(19) United States
(12) Patent Application Publication
(10) Pub. No.: US 2002/0066789 A1
(43) Pub. Date: Jun. 6, 2002

(54) Storage medium

(76) Inventor: Ting Fang Yen, BanQiao City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/729,306

(22) Filed: Dec. 5, 2000

(51) Int. Cl. G06K 19/00

(52) U.S. Cl. 235/487

(57) ABSTRACT

A data storage medium includes a flat substrate made of plastics with concentric rings of data tracks containing optically retrievable data formed on a first surface thereof. The substrate may be positioned in a compact disc-read only memory (CD-ROM) or similar optic data reading devices for retrieving the optically retrievable data. At least a second form of data is provided on a second surface of the substrate. The second form of data selectively includes a printed pattern including for example name, address and telephone number, a value adding chip, a magnetic strip and a bar code, but not limited thereto. To properly position the substrate on a disc tray of the CD-ROM, two arcuate ribs are formed on the first surface of the substrate concentric with the data tracks of the substrate. Alternatively, the substrate may be provided with arcuate end edges concentric with the data tracks for replacing the ribs.

### FIELD OF THE INVENTION

The present invention generally relates to data storage medium, and in particular to a data storage medium on which two or more forms of data are stored.

### BACKGROUND OF THE INVENTION

In a modem society, a variety of card-like data storage devices are commonly used for operating electronic devices and/or accessing electronic system. Examples include credit cards and bank cards. Most of these cards are made of plastics. These plastic cards are also used as door keys and personal identifications, such as membership cards. For general consumers, to suit oneself in such a modem world, one must carry a number of cards for different purposes. This certainly causes some problems for general consumers and the costs of purchasing and managing the cards will be increased if one possesses more cards.

It is thus desirable to provide a data storage medium in which two or more forms of data are stored for overcoming the above problem.

### SUMMARY OF THE INVENTION

Accordingly, an object of the present invention is to provide a data storage medium in which two or more forms of data are stored whereby the number of cards that a person needs is reduced.

Another object of the present invention is to provide a data storage medium in which two or more forms of data are stored whereby the overall cost for making and possessing cards in reduced.

A further object of the present invention is to provide a data storage medium in which a number of different forms of data are stored so as to reduce the cost for management and handling of cards.

To achieve the above objects, in accordance with the present invention, there is provided a data storage medium comprising a flat substrate made of plastics with concentric rings of data tracks containing optically retrievable data formed on a first surface thereof. The substrate may be positioned in a compact disc-read only memory (CD-ROM) or similar optic data reading devices for retrieving the optically retrievable data. At least a second form of data is provided on a second surface of the substrate. The second form of data selectively includes a printed pattern including for example name, address and telephone number, a value adding chip, a magnetic strip and a bar code, but not limited thereto. To properly position the substrate on a disc tray of the CD-ROM, two arcuate ribs are formed on the first surface of the substrate concentric with the data tracks of the substrate. Alternatively, the substrate may be provided with arcuate end edges concentric with the data tracks for replacing the ribs.

### BRIEF DESCRIPTION OF THE DRAWINGS

The present invention will be apparent to those skilled in the art by reading the following description of preferred embodiments thereof, with reference to the attached drawings, in which:

FIG. 1 is a perspective view showing a storage medium constructed in accordance with the present invention;

FIG. 2 is a perspective view showing a first embodiment of the storage medium of the present invention;

FIG. 3 is a perspective view showing a second embodiment of the storage medium of the present invention;

FIG. 4 is a perspective view showing a third embodiment of the storage medium of the present invention;

FIG. 5 is a perspective view showing a fourth embodiment of the storage medium of the present invention;

FIG. 6 is a perspective view of an alternative form of the storage medium of the present invention; and

FIG. 7 is a perspective view of the storage medium of FIG. 6 observed from an opposite side.

### DETAILED DESCRIPTION OF THE PREFERRED EMBODIMENTS

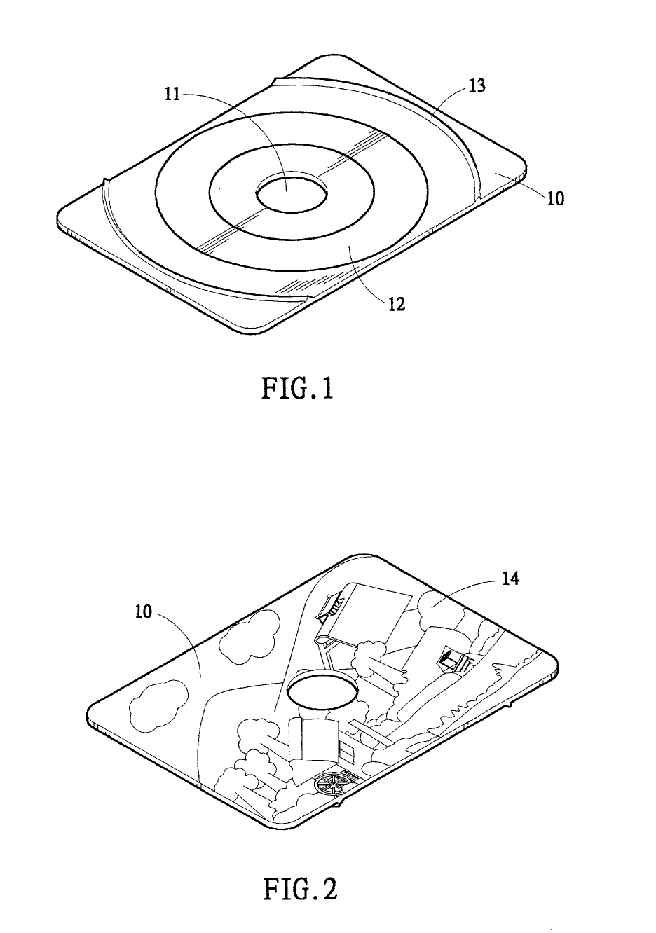

With reference to the drawings and in particular to FIG. 1, a storage medium constructed in accordance with the present invention comprises a thin flat substrate 10 having opposite surfaces. On a first surface of the substrate 10, a first data representation comprising a plurality of data tracks in the form of concentric rings 12 is formed. Data of first form is contained in the data tracks 12. At least one second data representation comprising data of a second form is formed on a second surface of the substrate 10. Therefore, two or more forms of data may be formed and stored in the same substrate 10.

The substrate 10 is preferably made of an insulative material, such as plastics. In the embodiment illustrated, the substrate 10 has a size substantially corresponding to a business card or a driver's license. A central hole 11 is defined in the substrate 10 for being loaded in for example a compact disc-read only memory (CD-ROM) or other optic data reading devices (not shown) for retrieving the data stored in the data tracks 12 (presuming the first form of data is optically accessible data). In this respect, the data tracks 12 are formed as data tracks of a regular compact disc having pits representing data stored therein whereby a laser beam of the CD-ROM may scan and pick up data stored in the data tracks 12. It is apparent to those skilled in the art that the first form of data may be data retrievable in different ways, such as data retrievable magnetically.

Preferably, two arcuate ribs 13 are formed on the first surface of the substrate 10 opposite to each other and symmetric with respect to the central hole 11 for properly positioning the substrate 10 on a disc tray of the CD-ROM.

The data stored in the data tracks 12 may contain any kind of data, including but not limited to commercial advertisements, profiles of a company, product catalogs, a personal resume whereby the storage medium may allow a user to carry and immediately present desired data to for example customers and interviewees.

As shown in FIG. 2, in an embodiment of the present invention, personal data, including name, telephone number, facsimile number, and e-mail address, may be printed on the second surface of the substrate 10. This allows the data storage medium of the present invention to serve as a business card in which personal data in electronic form are provided and stored in the data tracks 12 whereby people who receive the business card can easily download the data into a personal computer for preservation.

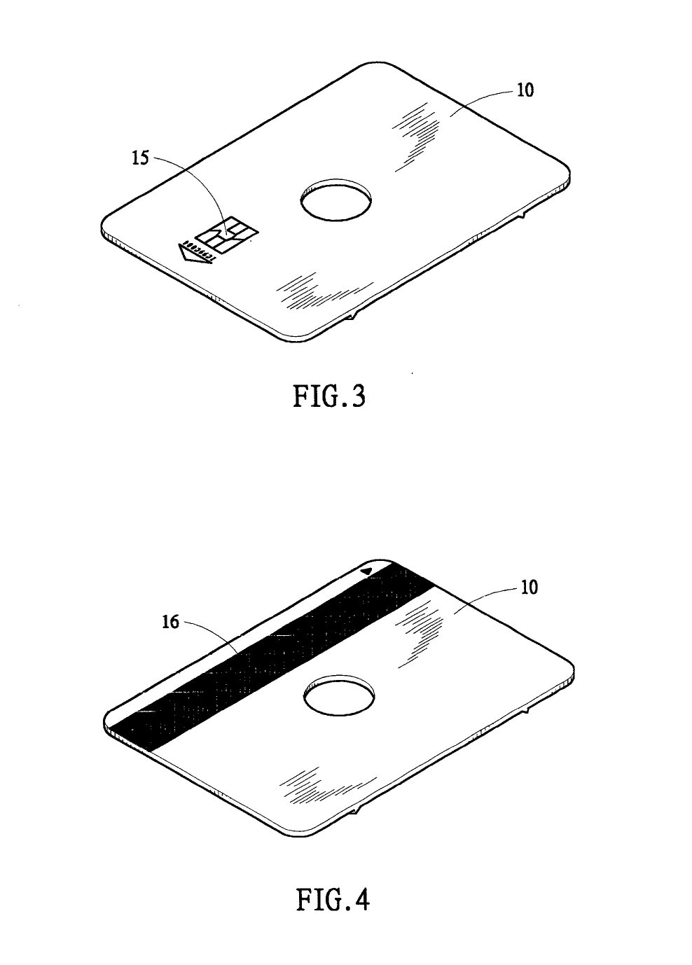

In another embodiment, as shown in FIG. 3, a value adding chip 15 may be attached to the second surface of the substrate 10 whereby the storage medium of the present invention may serve as a telephone card, a public transportation ticket or other tickets.

In a further embodiment, as shown in FIG. 4, a magnetic strip 16 is attached to the second surface of the substrate 10 whereby the storage medium of the present invention may serve as a credit card, a personal identification card, a bank card, a magnetic door key or a membership card.

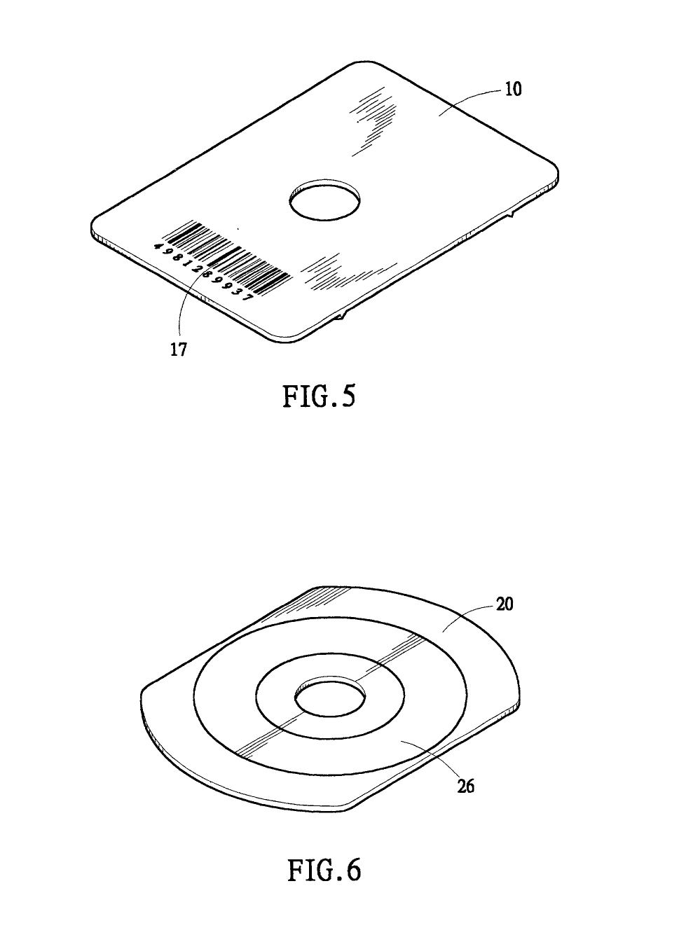

In yet a further embodiment, as shown in FIG. 5, a bar code 17 is printed on the second surface of the substrate 10 whereby the storage medium of the present invention may serve as an identification for a particular product or article.

Although several different embodiments have been described, it is apparent to those having ordinary skills to incorporate any of these embodiments together whereby a storage medium of the present invention may simultaneously combine any of these embodiments together. For example, a value adding chip (as shown in FIG. 3) and a magnetic strip (as shown in FIG. 4) may both be formed on the second surface of the substrate 10.

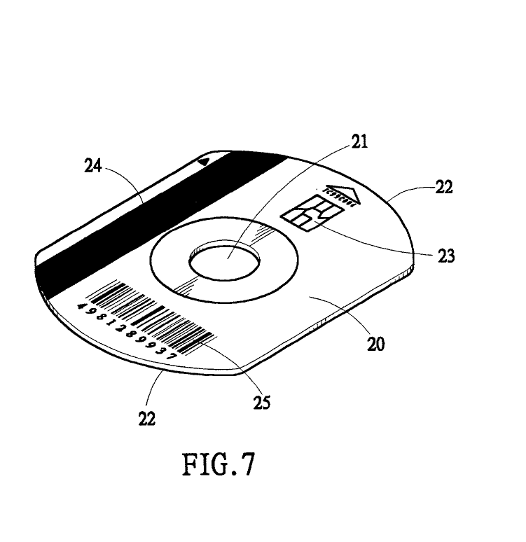

FIGS. 6 and 7 show an alternative form of the present invention comprising a flat substrate 20 made of an insulative material, such as plastics, defining a central hole 21. The substrate 20 has a size substantially corresponding to a business card with opposite ends being shaped to form arcuate edges 22 substantially concentric with the central hole 21.

A plurality of concentric data tracks 26 is formed on a first surface of the substrate 20 for storage of data therein. The data tracks 26 contain optically accessible data so that the data may be retrieved with a CD-ROM (not shown). The arcuate edges 22 allow the substrate 20 to be properly positioned in a disc tray of the CD-ROM.

Similar to the embodiments illustrated in FIGS. 3-5, a second data representation may be formed on a second surface of the substrate 20, including a value adding chip 23, a magnetic strip 24 and/or a bar code 25. If desired, different patterns may be printed on the second surface of the substrate 20.

It is apparent from the above description that a variety of functions may be combined together on a single card-like data storage medium described in accordance with the present invention. This provides economic value and convenience for the general consumers.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A storage medium comprising a flat substrate made of an insulative material having a first surface on which data tracks containing first data representation are formed and a second surface on which a second data representation is formed, the first data representation being adapted to be retrieved by an optic data reading device and the storage medium being adapted to be positioned in a support tray of the optic data reading device for the retrieve of the first data representation.

2. The storage medium as claimed in claim 1, wherein arcuate ribs are formed on the substrate on opposite sides of and concentric with the central hole for properly positioning the storage medium on the support tray of the optic data reading device.

3. The storage medium as claimed in claim 1, wherein the substrate comprises two opposite arcuate end edges for properly positioning the storage medium on the support tray of the optic data reading device.

4. The storage medium as claimed in claim 1, wherein the second data representation comprises a pattern printed on the second surface.

5. The storage medium as claimed in claim 1, wherein the second data representation comprises a chip attached to the second surface.

6. The storage medium as claimed in claim 1, wherein the second data representation comprises a magnetic strip formed on the second surface.

7. The storage medium as claimed in claim 1, wherein the second data representation comprises a bar code printed on the second surface.
